(19) United States
(12) Patent Application Publication
(10) Pub. No.: US 2015/0260452 A1
(43) Pub. Date: Sep. 17, 2015

(54) APPARATUS FOR RECOVERY OF VOLATILE ORGANIC COMPOUND VAPOR

(71) Applicant: Harley Marine Service, Inc., Seattle, WA (US)

(72) Inventor: Peter A. Hofmann, Elida, OH (US)

(73) Assignee: Harley Marine Service, Inc., Seattle, WA (US)

(21) Appl. No.: 14/716,441

(22) Filed: May 19, 2015

Related U.S. Application Data
(62) Division of application No. 12/248,335, filed on Oct. 9, 2008.

(51) Int. Cl. F25J 1/00; B01D 53/14; F17C 13/12; F17C 9/02; F17C 13/00

(52) U.S. Cl. CPC F25J 1/0025; F17C 9/02; F17C 13/004; F17C 13/12; B01D 53/14; F17C 2221/033

(57) ABSTRACT

Embodiments of the invention provide a self-contained unit which is automated for safety and efficiency recovers emissions present as a result of loading volatile organic compositions at marine or land based vessels or terminals. The unit is enclosed for protection of its components from wind, weather and the saltwater marine environment, while including venting for protection against possible vapor build-up. The unit also includes required support services and materials, and also includes structure for protection against transfer of explosion back into the cargo vessel or terminal.

### RELATED APPLICATIONS

This application is a divisional application of U.S. patent application Ser. No. 12/248,335, filed on Oct. 9, 2008, which is incorporated herein by reference in its entirety.

### BACKGROUND OF THE INVENTION

1. Field of the Invention

The present invention relates to recovery of volatile organic compound (VOC) fluids during loading or unloading from marine vessels, from petroleum production platforms or vessels or other such facility or location.

2. Description of the Related Art

Vapor recovery units such as those of U.S. Pat. No. 5,050,603 have been provided to recover volatile organic compound (VOC) emissions during or unloading of barges or other vessels from marine vessels, from petroleum production platforms or vessels or other such facility or location. U.S. Pat. No. 5,050,603 is owned by a related company of the assignee of the present application. U.S. Pat. No. 5,050,603 is incorporated herein by reference.

Typically, such a vapor recovery unit has been ship or barge mounted and traveled in open marine waters from port to port based on service demands. In such an environment, the unit was continually exposed to the marine atmosphere and elements, such as salt water, rain, wind, wave action and the accompanying corrosive nature they presented. In vapor recovery units of this type, a number of the components, including fluid handling mechanical elements such as vessels, tubing, connections and fittings, as well as control elements such as valves, meters and other instrumentation exposed to the marine atmosphere of an ocean or port environment. Further, the unit and its components have been required by their use and purpose to be present in the hazardous zones created by proximity to oil and gas production. Potential leakage of any VOC vapors from the unit in an already hazardous zone in proximity to oil and natural gas production was a problem and safety concern. Additionally, salt air corrosion of components in the unit and the possible leaking of vapors from the unit were undesirable in order to avoid environmental pollution.

An additional and separate safety concern was present due to the nature of the VOC fluids being transferred to the vapor recovery unit from a cargo tank of a barge or other transport vessel. Concern was present about the hazardous consequences of an explosion in the event one might occur in the equipment of the vapor recovery unit and then be transmitted back through piping and connections from the vapor recovery unit to the vapor space in a cargo tank of the barge or other vessel from which the vapors were being extracted. In transfer of the explosive vapors which accompany VOC fluids from a cargo space to another vessel such as the vapor recovery unit, the hazard of an explosion in the unit spreading back from the vapor recovery unit into another typically larger vapor space on the vessel was a concern.

Operation of a vapor recovery system such as that of U.S. Pat. No. 5,050,603 was labor intensive in that it was not automated. The operator was required to be present to run the system 24 hours a day during vapor recovery unit operations. The vapor recovery system required a full time operator to start the system, provide continuous adjustments during operations and shut the system down at the end of vapor recovery operations in connection with a load of oil. The operator was required to have taken specialized training to deal with issues that might arise out of operational problems. Successful operation of the unit was dependent on an operators' detailed knowledge of the process, and equipment settings of the various components. In addition, an operator was required to have mechanical ability to make repairs and adjustments, and instrumentation and control experience, such as record keeping skills in reading and documenting gauge settings and control functions.

Further, while vapor recovery units according to U.S. Pat. No. 5,050,603 were provided on skids in platform mounted form for mobility purposes, the units were not usable or self-sustaining on arrival at a job site. Outside support was required to be available at the job site in the form of electrical power, compressed air, and diesel fuel, and also of chemicals used in the process, such as methanol. This resulted in additional time and effort having to be spent at the job site in connecting the unit to these required sources and testing these connections during the unit set-up process before the vapor recovery unit was available for use. If the outside support and supplies were not present and available locally at the job site, vapor recovery was typically not available, in the absence of time-consuming prior planning and co-ordination.

Other systems used in the past for vapor recovery in the oil and chemical industries such as in have included cryogenic gas treatment and recovery by direct refrigeration, light lean oil absorption and activated carbon absorption.

### SUMMARY OF THE INVENTION

Briefly, the present invention provides a new and improved mobile apparatus for recovery of volatile organic compound vapor from a vaporous fluid containing volatile organic compounds during transfer from a storage container for pollution reduction. The mobile volatile organic compound (or VOC) recovery apparatus according to the present invention includes a vapor collection safety unit connected in a fluid transfer conduit from the storage container for receiving the vaporous fluid. The vapor collection safety unit contains a shutdown valve responsive to hazardous conditions to block the fluid transfer conduit. A scrubber unit is connected to the vapor collection safety unit and removes corrosive compounds from the vaporous fluid transferred from the storage container. A compressor unit is connected to the scrubber unit to compress the vaporous fluid after removal of corrosive compounds in the scrubber unit. A liquid-vapor separator module is connected to the compressor unit. The liquid-vapor separator module has a liquid outlet for liquids separated from vaporous fluid received from the compressor unit, and a vapor outlet for vapors separated from vaporous fluid received from the compressor unit. A cooler module is connected to the vapor outlet of the liquid-vapor separator module and cools the vapor received into a recovered volatile organic compound liquid and a recovered volatile organic compound vapor. A vapor scavenger unit is connected to the cooler module for utilizing the recovered volatile organic compound vapor.

The present invention also provides as a separate aspect from that described above a new and improved mobile apparatus for recovery of volatile organic compound vapor from a vaporous fluid containing volatile organic compounds during transfer from a storage container for pollution reduction. The mobile volatile organic compound (or VOC) recovery apparatus according to the present invention includes a scrubber unit connected to the vapor collection safety unit and removing corrosive compounds from the vaporous fluid transferred from the storage container. A compressor unit is connected to the scrubber unit to compress the vaporous fluid after removal of corrosive compounds in the scrubber unit. A liquid-vapor separator module is connected to the compressor unit. The liquid-vapor separator module has a liquid outlet for liquids separated from vaporous fluid received from the compressor unit and a vapor outlet for vapors separated from vaporous fluid received from the compressor unit. A cooler module is connected to the vapor outlet of the liquid-vapor separator module. The cooler module cools the vapor received into a recovered volatile organic compound liquid and a recovered volatile organic compound vapor. A fluid supply is provided in the apparatus for supplying operating fluid for the apparatus. A vapor scavenger unit is connected to the cooler module to utilize the recovered volatile organic compound vapor.

The present invention further provides as a separate feature from those described above a new and improved mobile apparatus for recovery of volatile organic compound vapor from a vaporous fluid containing volatile organic compounds during transfer from a storage container for pollution reduction. The mobile volatile organic compound (or VOC) recovery apparatus according to the present invention includes a vapor recovery module which includes a scrubber unit removing corrosive compounds from the vaporous fluid transferred from the storage container; a compressor unit connected to the scrubber unit and compressing the vaporous fluid after removal of corrosive compounds in the scrubber unit; and a liquid-vapor separator module connected to the compressor unit. The liquid-vapor separator module has a liquid outlet for liquids separated from vaporous fluid received from the compressor unit, and a vapor outlet for vapors separated from vaporous fluid received from the compressor unit. A cooler module provided as a part of the vapor recovery module is connected to the vapor outlet of the liquid-vapor separator module to cool the vapor received into a recovered volatile organic compound liquid and a recovered volatile organic compound vapor. A vapor scavenger unit of the vapor recovery module is connected to the cooler module for utilizing the recovered volatile organic compound vapor. According to this aspect of the present invention, a platform has the vapor recovery module mounted therewith; and an enclosure is mounted with the platform and encloses the vapor recovery module.

The present invention further provides as a separate feature from those described above a new and improved mobile apparatus for recovery of volatile organic compound vapor from a vaporous fluid containing volatile organic compounds during transfer from a storage container for pollution reduction. The mobile volatile organic compound (or VOC) recovery apparatus according to the present invention includes a scrubber unit to remove corrosive compounds from the vaporous fluid transferred from the storage container. The scrubber unit has sensors for monitoring process conditions therein and control members connected therewith for controlling fluid conditions therein. A compressor unit is connected to the scrubber unit and compresses the vaporous fluid after removal of corrosive compounds in the scrubber unit. The compressor unit has sensors for monitoring process conditions therein and control members connected therewith for controlling fluid conditions. A liquid-vapor separator module is connected to the compressor unit, and has a liquid outlet for liquids separated from vaporous fluid received from the compressor unit and a vapor outlet for vapors separated from vaporous fluid received from the compressor unit. The liquid-vapor separator module has sensors for monitoring process conditions therein and control members connected therewith for controlling fluid conditions. A cooler module is connected to the vapor outlet of the liquid-vapor separator module and cools the vapor received into a recovered volatile organic compound liquid and a recovered volatile organic compound vapor. The cooler module has sensors for monitoring process conditions therein and control members connected therewith for controlling fluid conditions. A vapor scavenger unit is connected to the cooler module and utilizes the recovered volatile organic compound vapor. The vapor scavenger unit has sensors for monitoring its process conditions and control members connected for controlling fluid conditions. A processor control computer has a stored established set of state point stored therein to establish operating conditions for the apparatus. The processor control computer monitors the sensors and adjusts the control members of the apparatus according to the established operating conditions.

### BRIEF DESCRIPTION OF THE DRAWINGS

The objects, advantages and features of the invention will become more apparent by reference to the drawings appended thereto, wherein like numerals indicate like parts and wherein an illustrated embodiment of the invention is shown.

FIG. 1 is a schematic block diagram of a vapor recovery unit according to the present invention.

FIG. 2 is a piping and instrumentation diagram of the vapor recovery unit of FIG. 1.

FIG. 3 is a schematic diagram of a vapor collection safety unit of the vapor recovery unit of FIG. 1.

FIG. 4 is a plan view of the internal layout of the vapor recovery unit of FIG. 1.

FIG. 5 is an isometric view of the vapor recovery unit of FIG. 1.

FIG. 6 is a front elevation view of the vapor recovery unit of FIG. 1.

FIGS. 7 and 8 are side elevation views the vapor recovery unit of FIG. 1.

FIG. 9 is a rear elevation view of the vapor recovery unit of FIG. 1.

FIG. 10 is another isometric view of the vapor recovery unit of FIG. 1.

FIG. 11 is a schematic diagram depicting the arrangement of FIGS. 11A, 11B, 11C, and 11D.

FIGS. 11A, 11B, 11C, and 11D when arranged as illustrated in FIG. 11 are an example state point diagram of a vapor recovery unit like that shown in FIG. 1.

### DETAILED DESCRIPTION OF THE PREFERRED EMBODIMENTS

In the drawings, the letter A designates a mobile apparatus according to the present invention for recovery of volatile organic compound vapor from a vaporous fluid containing volatile organic compounds during transfer from a storage container for pollution reduction. The vaporous fluid is typically a hydrocarbon liquid being loaded or unloaded from a storage container, such as a cargo tank. One example of such a cargo tank is a marine vessel, such as a barge or tanker. Another type of cargo tank is a shore-based petroleum tank. It should be understood that the apparatus A may be used with other types of storage containers for bulk storage of hydrocarbons, including those at offshore platforms as well.

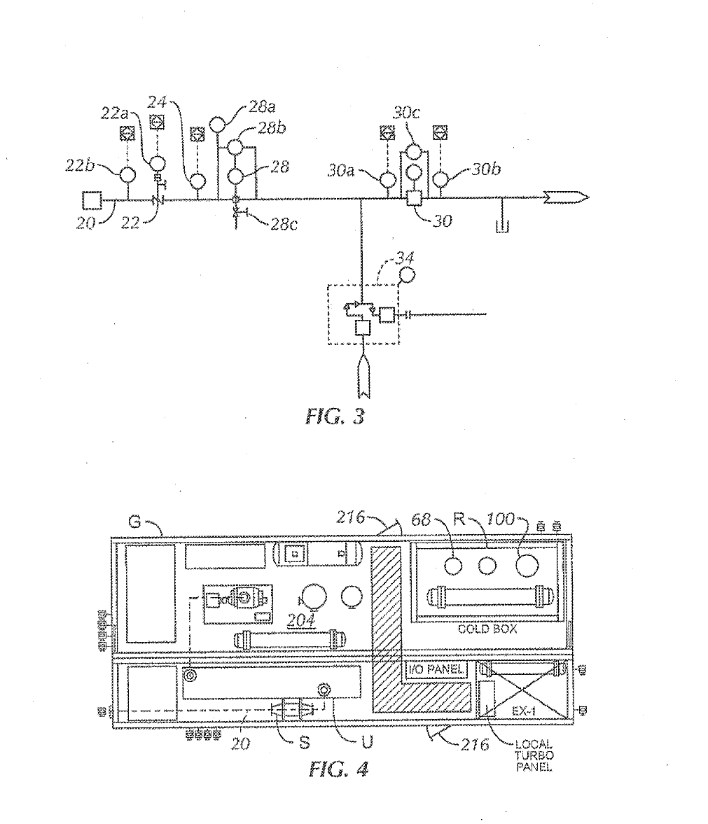

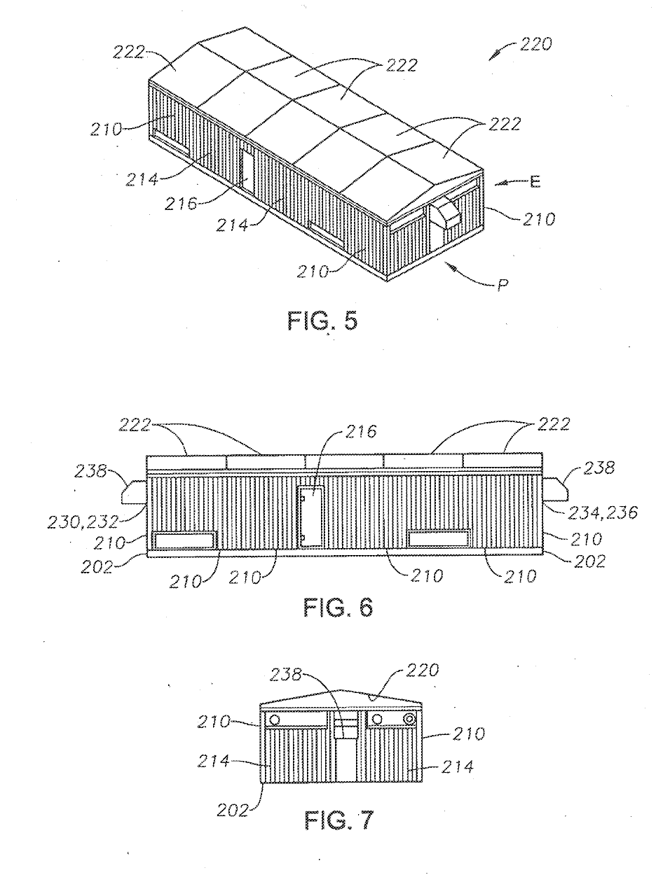

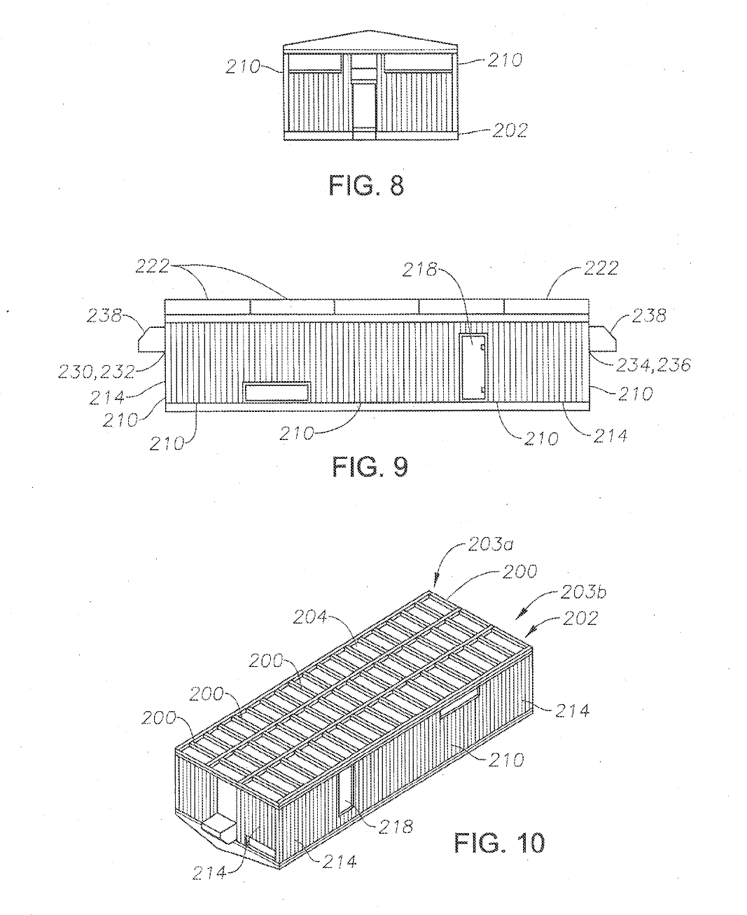

The mobile volatile organic compound (or VOC) recovery apparatus A according to the present invention includes a vapor collection safety unit S connected in a fluid transfer conduit 20 from the storage container for receiving the vaporous fluid. The vapor collection safety unit S contains a shutdown valve 22 (FIG. 3) responsive to hazardous conditions in the apparatus A to block the fluid transfer conduit 20. In this way, any potential hazard such as fire, flame or incipient explosion in the apparatus A is blocked from passage back to the storage container through the fluid transfer conduit 20.

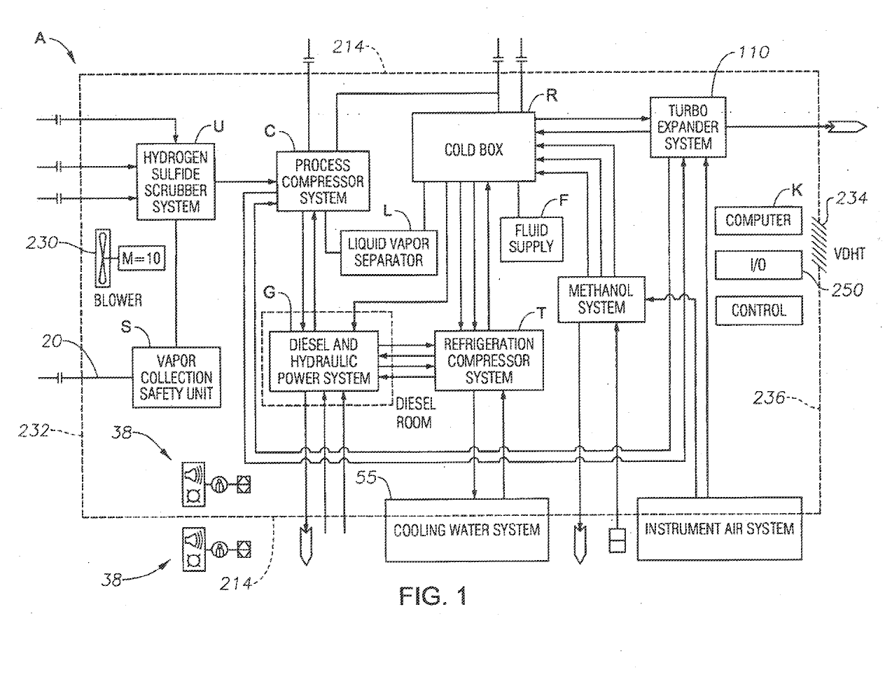

A scrubber unit U (FIG. 1) is connected to the vapor collection safety unit S to remove corrosive compounds from the vaporous fluid transferred from the storage container. A compressor unit C is connected to the scrubber unit U to compress the vaporous fluid after removal of corrosive compounds in the scrubber unit U.

A liquid-vapor separator module L is connected to the compressor unit U. The liquid-vapor separator module L has a liquid outlet 16 for liquids, at this stage principally water, separated from vaporous fluid received from the compressor unit U. The liquid-vapor separator module L also includes a vapor outlet 26 for vapors, typically principally unliquified hydrocarbons, separated from vaporous fluid received from the compressor unit U.

A cooler module R is connected to the vapor outlet 26 of the liquid-vapor separator module L and cools the vapor received into a recovered volatile organic compound liquid and a recovered volatile organic compound vapor. As will be set forth, the cooler module R typically takes the form of several sequentially connected cooler stages, each cooling an incoming vapor fluid and separating the incoming vapor into a liquid and a volatile organic compound vapor. A vapor scavenger unit G is connected to the cooler module R for utilizing the recovered volatile organic compound vapor. The utilization may take the form of consumption of the recovered VOC vapors as fuel in an engine or some suitable form of adsorption. In its preferred embodiments, according to the present invention the vapor scavenging unit G is typically a diesel engine adapted to utilize light VOCs as a supplemental fuel which is coupled to either an electricity generator which provides some of the power needed by the apparatus A, or to a hydraulic pump. The present invention also contemplates that the vapor scavenging unit G may take the form of a molecular sieve adsorber capable of absorbing the residual light VOCs.

The apparatus A also includes a fluid supply F for supplying operating fluid for operation of the other units during vapor recovery operations. When the vapor scavenger unit G takes the form of a diesel engine consuming the volatile organic fluid vapor received from the cooler module R, the fluid supply F includes a fuel supply for the engine. The fluid supply F also includes a supply of coolant supply of coolant fluid for the cooler module R.

The vapor collection safety unit S, scrubber unit U, compressor unit C, liquid-vapor separator module L, cooler module R, fluid supply F and vapor scavenger unit G take the form of a vapor recovery module M and are mounted on a common platform P of the apparatus. With the present invention, the term “platform” is not restricted to a platform in the sense of a highway flatbed but is intended to include structures for attaching process equipment to a ship or barge or skids after transport by a trailer-type or road transport vehicle over on land. The apparatus A is mounted upon the platform P. As will be set forth, the platform P is typically formed of two separate skid sections, for road transport regulation purposes, which are assembled together to support the apparatus at the job site, whether in a marine vessel or on land.

According to the present invention, an enclosure E is mounted with the platform P and encloses the vapor recovery module M. The enclosure E is waterproof and weatherproof, being made of steel structure and plates, or comparable materials. The enclosure E is also vented during operations to provide a safe access to operational personnel. The enclosure E also has conventional sensors and associated alarms/indicators suitably placed within it to continuously test the atmosphere, to guarantee the safety of those who enter.

Tuning now to the vapor collection safety unit S, the shutdown valve 22 (FIG. 3) is a pressure actuated flow control valve of the type furnished with a fail-safe operator, open and closed position limit switches, as well as being capable of manual actuation. The shutdown valve 22 and other instrumentation of the apparatus A is connected to an instrumentation air supply I (FIG. 1).

A position sensor 22a is associated with the shutdown valve, as are pressure/temperature sensors indicated schematically at 22b located upstream of the valve 22 on transfer conduit 20. The sensors 22a and 22b monitor conditions relating to the apparatus associated with the shutdown valve 22 and provide data readings to the computer K. The pressure actuated shutdown valve 22 is actuated in response to detection of a hazardous condition such as an abnormal or hazardous temperature or pressure in the apparatus A by the computer K to block the fluid transfer conduit 20. The shutdown valve 22 may also be actuated manually, as noted.

The vapor collection safety unit S also includes a suitable pressure/temperature sensor 24 located downstream of the valve 22 in conduit 20 to activate audible and visual alarms 26 in response to detection of either low or high conditions pressure conditions in the transfer conduit 22. The vapor collection safety unit S also includes a cartridge filter 28 to prevent unwanted particles in the conduit from entering the apparatus A and to reduce plugging potential in a detonation arrestor 30 of the vapor collection safety unit S. It should be understood that a basket strainer might also be used, if desired.

The cartridge filter 28 is provided with a gauge pressure transmitter 28a and a differential pressure sensor or transmitter 28b. The transmitters 28a and 28b monitor conditions relating to the apparatus associated with the cartridge filter 28 and provide data readings to the computer K. The gauge transmitter 28a monitors pressure conditions in the conduit 20 upstream of the filter 28, while the differential pressure sensor/transmitter 28b senses and monitors conditions relating to possible blockage or plugging of the filter 28. A sample valve 28c is also connected to the filter 28 for testing and sampling purposes.

The detonation arrestor 30 is preferably of the type intended for use with what are known as “Class D Vapors.” The detonation arrestor includes temperature sensors 30a and 30b on inlet and outlet sides, respectively of arrestor element 30 to monitor conditions relating to the arrestor 30 and provide data readings to the computer K. A differential pressure gauge 30c senses and monitors conditions relating to pressure drop across the arrestor 30. The vapor collection safety unit S also includes a vacuum relief valve 34 connected to the conduit 20 between the cartridge filter 28 and the arrestor 30.

The foregoing equipment and components of the vapor collection safety unit S are mounted in a single skid located on the platform P beneath the conduit 20 leading to the scrubber unit U. A conventional control panel 38 (FIG. 1) is provided for operator annunciation and interface, being mounted on the vapor collection safety unit S. The control panel may include at least a horn, a suitable number of strobe lights for annunciation system alarms and emergency push/pull buttons for shutdowns of the apparatus A as required by the process or by any appropriate governmental regulation.

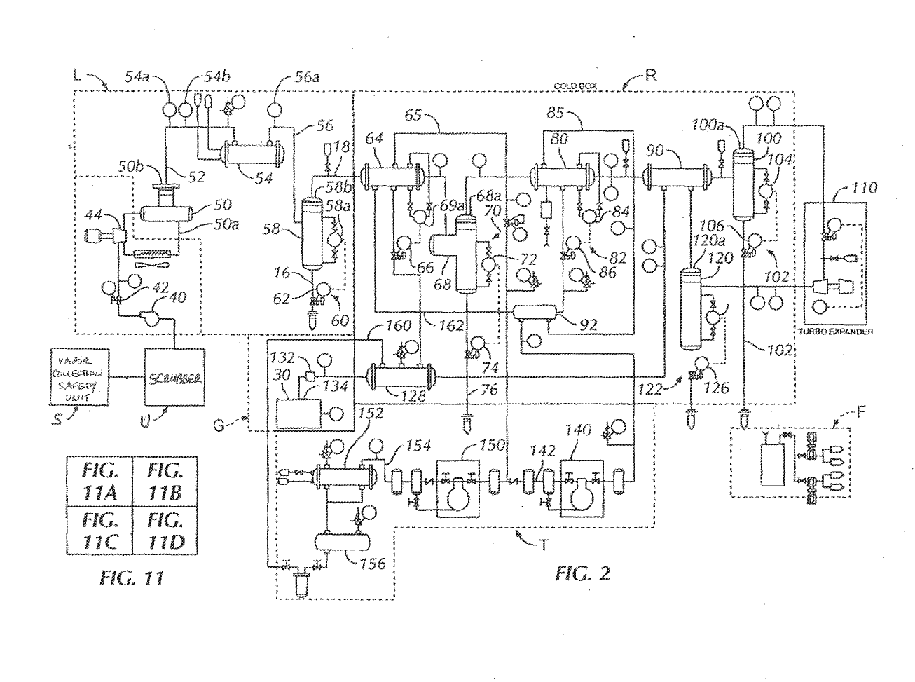

In vapor recovery with the apparatus A, a direct refrigeration portion of the process occurs in which the VOC emissions first pass from the storage container through the transfer conduit 20 and the vapor collection safety unit S to the scrubber unit U. Scrubber unit U is a suitable form of caustic scrubber where potential corrosive or sulfurous components of the type which may be present in the hydrocarbons in the vapor stream are removed. Flow of the vapor from the storage container and the vapor collection safety unit S through the caustic scrubber is induced by an inline blower 40 (FIG. 2) located downstream of the caustic scrubber U. The blower 40 is fitted with a valve 42 which may be opened by a control mechanism 42a in response to the computer K to discharge the vapor through vent 18 to atmosphere in an emergency. Manual operating capability of the valve 42 is also provided.

From the blower, the scrubbed vapor passes to a compressor 44 which boosts the pressure of the vapor stream to a state point of pressure and temperature established by the process control computer K, as will be set forth. The compressed vapors exiting from the compressor 44 are fed to a liquid-vapor separator 50 of the liquid-vapor separator module L. The liquid stream exiting from a liquid outlet 50a at the bottom of the liquid-vapor separator 50 is essentially hot water, free of oil, which may be recycled.

A vapor outlet 50b of the liquid-vapor separator 50 transfers the exiting separated vapor stream through a line 52 so that the separated vapor stream passes through a compressor discharge cooler 54 of the cooler module R, utilizing cooling water from a cooling water supply 55 (FIG. 1) as the cooling medium. The discharge cooler 54 cools the vapor stream to a temperature range established by the process control computer K. A temperature sensor 54a and a pressure sensor/transmitter 54b are located upstream in the line 52 of the cooler 54 to provide data readings and indications to the process control computer K.

The cooled vapor stream from the compressor discharge cooler 54 passes through a line 56 to an after cooler knock-out drum 58 of the liquid-vapor separator module L. A temperature sensor 56a is located downstream of the cooler 54 to provide data readings and indications to the process control computer K. The cooler knock-out drum 58 is fitted with an oily water drain valve control system 60 including a control valve 62 controlled by the computer K based on readings furnished from a differential pressure transmitter 58a to drain hydrocarbon liquids and water through conduit 16 associated with the storage container.

Vapors exit from an outlet 58b at the top of the knock-out drum 58 and travel through outlet 18 to enter a first high temperature chiller 64 of the cooler module R. In the first high temperature chiller module 64, the entering vapor is cooled with a low pressure refrigerant which is preferably methanol from a methanol or coolant supply unit 68 of the fluid supply F. The vapor is cooled in the chiller 64 to a temperature range established by the process control computer K to produce a vapor-liquid mixture.

A differential pressure sensor/transmitter (not shown) is connected to the first high temperature chiller module 64 to provide data readings and indications to the process control computer K. A level control valve 66 is controlled by the computer K based on readings from the differential pressure transmitter 64a to control fluid levels in the chiller 64.

The fluid mixture from the chiller 64 is fed to a cold three-phase knock-out drum 68 which is fitted with a hydrocarbon liquid drain system 70 for recovering liquid hydrocarbons.

The hydrocarbon liquid drain system 70 includes a differential pressure sensor 72 to provide data readings and indications to the process control computer K and a liquid control valve 74 controlled by the computer K to control fluid levels in the knock-out drum 68. Liquid hydrocarbons recovered by knock-out drum 68 which are then reinjected into the cargo loading line through a line 76.

The vapor portion of the mixture exits from an outlet 68a at the top of the three-phase knock-out drum 68 and enters a low temperature chiller 80 where it is cooled by low temperature refrigerant to a temperature range established by the process control computer K. A hydrocarbon liquid drain system 82 includes a differential pressure sensor 84 to provide data readings and indications to the process control computer K and a liquid control valve 86 controlled by the computer K to control fluid levels in the low temperature chiller 80.

Upon exiting from the low temperature chiller 80, the gas passes through a gas-gas exchanger 90 where it is further cooled to a temperature range established by the process control computer K and partially condensed by heat exchange with cold expanded vapors. The liquid from control valve 86 travels to an exchanger 92 which serves as a subchiller for refrigeration vapor, as will be described. Exchanger 92 is also connected to chiller 64 and to low temperature chiller 80.

The gas from exchanger 90 then travels to a first low temperature accumulator 100 fitted with a hydrocarbon liquid drain system 102 for liquid hydrocarbon recovery. The hydrocarbon liquid drain system 102 includes a differential pressure sensor 104 to provide data readings and indications to the process control computer K and a liquid control valve 106 controlled by the computer K to control fluid levels in the low temperature accumulator 100. The residual vapors exit from an outlet 100a at the top of the low temperature accumulator 100 and are fed to a turbo-expander 110 which expands the vapor to a pressure established by the process control computer K. Turbo-expander 110 further cools the vapors to a temperature established by the process control computer K causing further vapor condensation.

The cooled, expanded vapor-liquid mixture from turbo-expander 110 is fed to a second low temperature accumulator 120 fitted with a hydrocarbon liquid drain system 122 for recovering liquefied hydrocarbons for reinjection into the cargo. The hydrocarbon liquid drain system 122 includes a differential pressure sensor (not shown) to provide data readings and indications to the process control computer K and a liquid control valve 126 controlled by the computer K to control fluid levels in the accumulator 120.

The cold separated vapor from accumulator 120, typically now mainly methane, with some ethane, propane and butane, exits from an outlet 120a at the top of the second low temperature accumulator 120 and is used as a cooling medium in the gas-gas exchanger 90 before entering an exchanger 128 which serves as a refrigerant subcooler. Vapor from the exchanger 128 after passage through a flame arrestor 132 enters the vapor scavenging unit G at a temperature and pressure established by the process control computer K.

Typically, the vapor scavenging unit G takes the form of a diesel engine 134 which is also provided with diesel fuel from a diesel fuel tank (not shown) of the fluid supply F. Power generated by the diesel engine 134 is used to drive hydraulic pumps which power the rotating equipment of the apparatus A with the possible exception of the blower 40, and an electricity generator (not shown) which powers a pump or pumps in the caustic scrubber U; the blower 40; and requisite instrumentation and lights for the apparatus A.

Refrigeration for cooling purposes in the units of the apparatus A is provided by low pressure compressor 140 and high pressure compressor 150 fitted in the conventional manner with ancillary filters, separators, and accumulators associated with such equipment. The compressed refrigerant exiting from the high pressure compressor 150 is fed to a refrigerant condenser 152 via line 154. The refrigerant condenser 152 is cooled with cooling water. The cooled compressed refrigerant is then fed to a refrigerant accumulator 156 from which it passes via the refrigerant subcooler 128 then via line 160 to the high temperature chiller 64 to provide cooling for the vapor stream.

Part of the refrigerant exits from the high temperature chiller 64 via line 65 and is routed back to the inlet of the high pressure compressor 150 for recompression and recycling. The remainder of the refrigerant from chiller 64 then flows through line 162 through exchanger 92 to low temperature chiller 80 to provide cooling. The refrigerant exits from chiller 80 through line 85 and is routed through exchanger 92 which serves as a subchiller for refrigeration vapor being returned to the inlet of the low pressure compressor 140. The low pressure compressor 140 discharges refrigerant in line 142 which routes the refrigerant into the inlet of the high pressure compressor 150, completing the processing cycle.

The apparatus A is a complete, self-contained vapor processing plant, and as such weighs about 180,000 pounds when fully loaded with operating fluids. To support this weight and provide a rigid mounting to a barge, the vapor recovery module M is supported by the platform P which is constructed of carbon steel I-beams 200 of suitable size, designed with cross bracing and welded together to form a 20 foot wide by 48 foot long base 202 in the disclosed embodiment. The base 202 is preferably made from two separate skids 203a and 203b, each forty eight feet long, one being eleven feet wide and the other being nine feet wide. This is done to allow for shipping to a barge or other location for installation as each of the two skids of the base 203a and 203b can be shipped separately and within current transport regulations.

The skids 203a and 203b when connected to form the base 202 have a floor 204 (FIG. 4) mounted to form the platform P. The floor 204 (FIG. 4) of the platform is made from a suitable number of carbon steel deck plate members, which are welded together to form an interlocking pattern upon the I-beams 200 of the base 202. Appropriately located floor drains are installed in the deck plates of the floor 204, and have threaded couplings that may be plugged when the apparatus A is moved after installation on a barge, or when otherwise necessary.

The enclosure E is formed from a frame of carbon steel tube members 210 of suitable size and strength that are welded in positions so that they extend upwardly around the perimeter of the base 202. Cross-members or supports as required are welded as needed for strength and to provide mounting locations for a set of panels or side wall members 214. The side wall members 214 form side walls on side and end wall segments of the enclosure E. The side wall members 214 are bolted or otherwise mounted to the tube members 210 in order to be removable for maintenance. The junctures of the side panels 214 with the tube members 210 are provided with elastomer seals to prevent water entry or exit and provide protection for the equipment of the apparatus A mounted within the enclosure E. The enclosure E is provided with a suitable number of fore and aft marine doors 216 and 218, respectively, together with various hinged smaller panels as may be required to be opened during preparation for operation of the apparatus A, or for access to inlet or outlet ports or connection points associated with components of the apparatus A.

The enclosure E is provided with a roof 220 formed of roof panels 222 mounted above the side wall members with appropriate supports and bracing, if required. The roof panels 222 are sloped and are also removable for maintenance. The sloped roof panels 222 are also removably mounted by bolts to the tube members of the framework of the enclosure E. As with the side wall members 214, the roof panels 222 are provided with elastomer seals at their mounting with other components of the enclosure E. The tubes 210 of the framework and both the side wall panels 214 and roof panels 222 of the enclosure E are painted with a suitable weather resistant marine epoxy.

A ventilator fan 230 is mounted in an upper portion 232 of end side panel 214 to draw in and circulate air within the interior of enclosure S, while an outlet vent 234 is mounted in an upper portion 236 of an opposite end side panel to allow outlet circulation of air from the enclosure E. Suitable hoods or canopies 238 are mounted above the fan 230 and vent 234 to prevent entry of rain or other weather elements into the enclosure E.

The apparatus A is mounted within the enclosure E as a self-supporting and self-contained unit, and provides all its own support services. The generator 138 is installed on a power take off from the diesel engine 134, allowing supply of the electrical power necessary to support operations of the apparatus A. Diesel fuel in fuel tank 136 and coolant chemicals in coolant supply unit 67 of the fluid supply F are stored in the enclosure E in tanks designed for that purpose. Compressed air is supplied by an onboard air compressor of the instrumentation air system I. These features allow the apparatus A capable of transport or movement from ship to land based operations or the opposite in a short period of time. The required automated functions are located in the enclosure E, eliminating the requirement of a separate and additional remote operations building.

In the mobile volatile organic compound (or VOC) recovery apparatus according to the present invention the component units of the vapor recovery module M have sensors for monitoring vapor recovery process conditions, including pressure sensors and temperature sensors, and control members including valves for controlling fluid flow and transfer conditions in the apparatus A. The apparatus A also includes a processor control computer K which has a stored established set of state points for the components of the vapor recovery module M to establish operating conditions for the apparatus A.

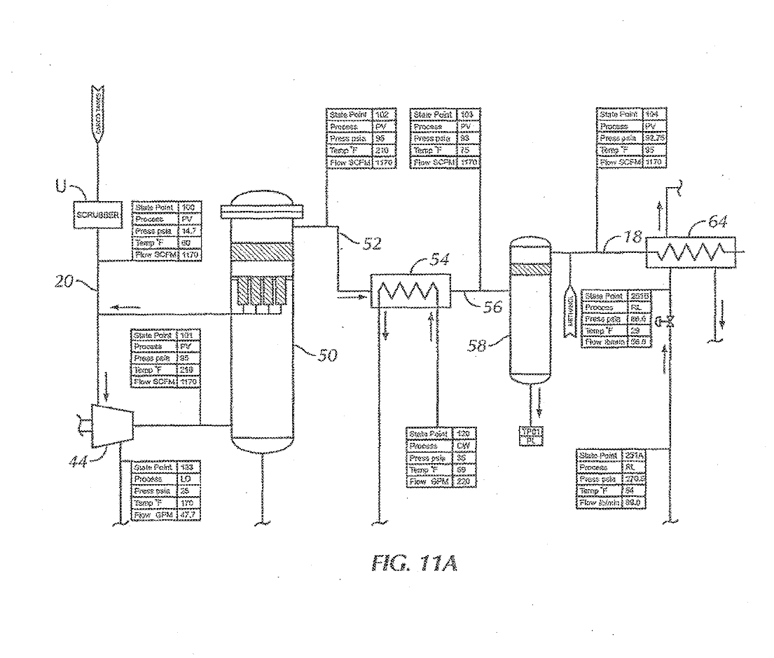

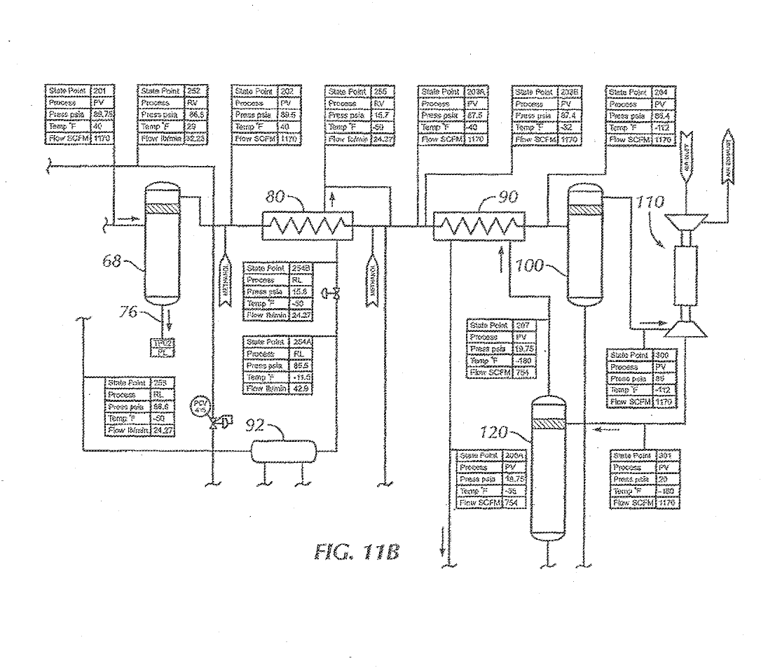

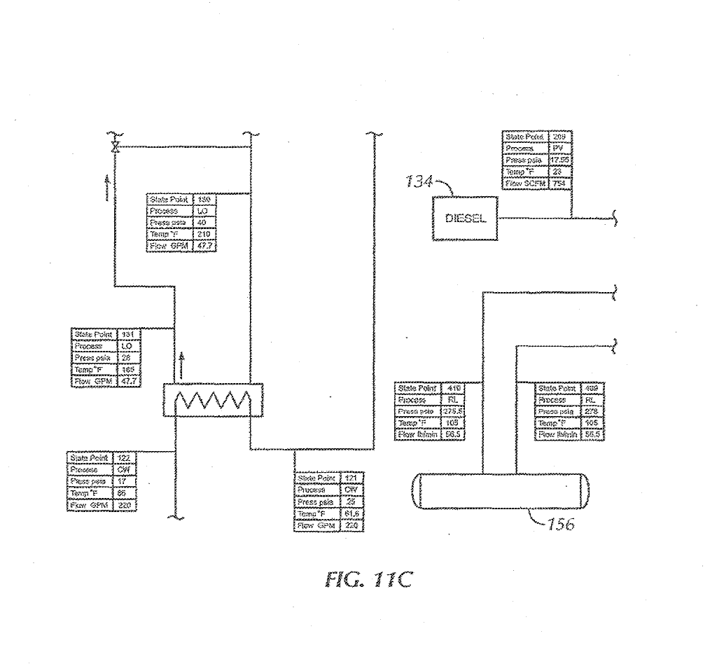

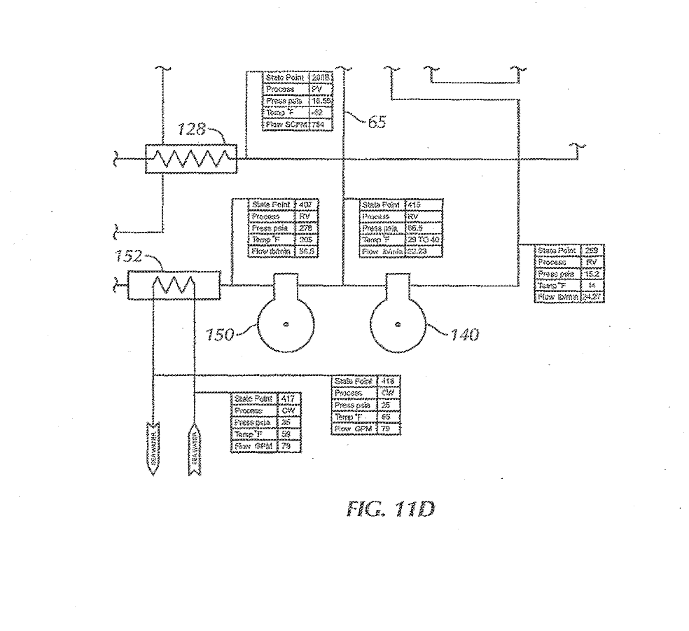

FIGS. 11A, 11B, 11C, and 11D represent an example state point diagram of operating conditions for the apparatus A. The processor control computer K monitors the sensors and adjusts the control members of the apparatus A according to established operating conditions, such as those depicted in the state point diagram of the composite FIGS. 11A, 11B, 11C, and 11D. It should be understood that the parameters values of temperature, pressure and the like are given by way of example. The computer K has an associated operator interface panel 250 with operator touch screen for monitoring and control purposes.

The computer K in a preferred embodiment of the present invention takes the form of a programmable logic controller, such as an ALLEN-BRADLEY™ Model PLC-5, or a programmable automation controller, such as an ALLEN-BRADLEY™ CompactLogix Model L43. The computer K permits user or operator selection of automatic, manual, or maintenance modes of vapor recovery operation. The computer K also permits conventional step sequencer logic for start-up control and provides safety interlocks to meet safety and other regulations.

It should be understood that other types of process control computers, such as personal computers, microprocessors or process controller may be used, if desired. The computer K receives input data from many sensors associated with units in the apparatus A, analyzes and monitors such data. In addition the computer K contains programmed therein an established set of state points and other parameters to establish operating conditions for the apparatus A. Based on the established set of state points and parameters, as well as the data readings from the temperature and pressure sensors in the apparatus A, the computer K sends signals to mechanical and electrical control members or valves to adjust system operation and efficiency.

According to the present invention, automation of vapor recovery operations allows for more efficient operations. It also eliminates the need for a full time operator and thus can afford a considerable saving of personnel costs. The computer K also permits independent recording of performance to determine both efficiency of the system and compliance with regulatory mandates.

In addition, the computer K prevents equipment damage by sensing problems with system operations before a major problem presents itself that could otherwise cause damage to person and property. Further, the computer K monitors and regulates the safety systems present into the apparatus A.

The control system associated with the computer includes sensors located throughout the unit to monitor a complex set of parameters to tell the logic controller how the system is working. As has been set forth, the state point diagram depicted in the drawings is an illustrative example of established operating conditions. The sensors in the apparatus A involved in vapor recovery operations take the form of pressure transmitters mounted inline, either differential pressure transmitters or gauge pressure transmitters. Also, where desired, conventional visual indicators may be located in the vapor recovery unit in conjunction with the pressure transmitters and elsewhere for operator observation and monitoring. In a preferred embodiment, the sensors are of the type available as ROSEMOUNT™ 3051 S series.

The differential pressure transmitters previously described herein serve as level controllers, to furnish data readings and direct the computer K to automatically drain a knockout vessel of condensed hydrocarbons or flow more refrigerant into a heat exchanger. The pressure transmitters of the apparatus A monitor process pressure conditions and provide data readings to the computer K for monitoring purposes during vapor recovery operations. The temperature sensors/transmitters of the apparatus A permit monitoring of process temperature conditions, and provide temperature data readings to the computer K for that purpose. In a preferred embodiment, the sensors are of the type available as ROSEMOUNT™ 248.

The control system of the apparatus A operates under of the computer K, and contains servomechanisms and valve operators to automatically adjust vapor recovery operations based on input values detected by the various pressure and temperature sensors previously discussed. The computer system K has associated with it the control members or mechanisms in the form of valves of the apparatus S as described above.

An operator interface panel 250 of the computer K displays in real time data about present vapor recovery operations. A preferred display on the operator interface panel 250 takes the form of a piping and instrumentation diagram of the system on a touch screen display. The operator interface panel 250 allows the operator to make manual adjustments to settings and controls as required. The operator interface panel 250 also displays both real time and saved data on current and past operations.

The operator interface panel 250 allows control of operation of control members such as valves and servomechanisms, such as those described above, to properly control the vapor collection safety unit S, scrubber unit U, compressor unit C, liquid-vapor separator module L, cooler module R, fluid supply F and vapor scavenger unit G of vapor recovery module M The operator interface panel 250 includes an industrial monitor with appropriate software, and mouse and keyboard controls mounted on the front of the panel. It should be understood that a touch screen may be used instead of an industrial monitor.

If desired, a slave computer unit may also be provided. In such a case, the slave unit can be any suitable computer that capable of receiving signals from the controller of the computer K. Such a slave unit would usually be located in the vicinity of the control center and operator interface panel 250.

According to the present invention, the term “volatile organic compounds” (VOC) refers to hydrocarbon or hydrocarbon derived compounds containing from 1 to 12 carbon atoms.

The term “light VOCs” refers to hydrocarbon or hydrocarbon derived compounds having from 1 to 4 carbon atoms. Further, according to the present invention, the term “light hydrocarbons” refers to C₄ and lighter hydrocarbons.

The apparatus A is particularly suited for use in the oil and chemicals industry for recovery of volatile organic compounds from a process stream containing such compounds. The mobile volatile organic compound (or VOC) recovery apparatus A according to the present invention meets or exceeds current safety standards for operation in the petroleum industry and marine operations on an oil barge or tanker as defined by United States Coast Guard Regulation and American Bureau of Shipping.

By enclosing the system in the water-tight, vented enclosure E, the mobile volatile organic compound (or VOC) recovery apparatus according to the present invention meets current regulatory standards, prevent corrosive damage to sensitive equipment by atmospheric elements, and prevent water damage to controls and a safe environment for operators.

The mobile volatile organic compound (or VOC) recovery apparatus A according to the present invention increases utilization and availability of VOC recovery by allowing a system to be transferred to active equipment and locations that are in current need of such a system. An apparatus according to the present invention eliminate the cost of separately providing at those locations supplies used by the system and support services such as fuel and coolant.

The mobile volatile organic compound (or VOC) recovery apparatus A according to the present invention includes an automated VOC vapor recovery system to eliminate the constant attention of an operator, reducing labor costs and making the system safer to operate.

Having described the invention above, various modifications of the techniques, procedures, material, and equipment will be apparent to those in the art. It is intended that all such variations within the scope and spirit of the appended claims be embraced thereby.

1. A mobile apparatus for recovery of volatile organic compound vapor from a vaporous fluid containing volatile organic compounds during transfer from a storage container for pollution reduction, comprising:
a vapor collection safety unit connected in a fluid transfer conduit from the storage container for receiving the vaporous fluid, the vapor collection safety unit containing a shutdown valve responsive to hazardous conditions to block the fluid transfer conduit;
a scrubber unit connected to the vapor collection safety unit removing corrosive compounds from the vaporous fluid transferred from the storage container;
a compressor unit connected to the scrubber unit compressing the vaporous fluid after removal of corrosive compounds in the scrubber unit;
a liquid-vapor separator module connected to the compressor unit, the liquid-vapor separator module having a liquid outlet for liquids separated from vaporous fluid received from the compressor unit and a vapor outlet for vapors separated from vaporous fluid received from the compressor unit;
a cooler module connected to the vapor outlet of the liquid-vapor separator module and cooling the vapor received into a recovered volatile organic compound liquid and a recovered volatile organic compound vapor; and
a vapor scavenger unit connected to the cooler module for utilizing the recovered volatile organic compound vapor.

2. The apparatus of claim 1, wherein the storage container is a cargo tank.

3. The apparatus of claim 2, wherein the cargo tank is located in a marine vessel.

4. The apparatus of claim 1, wherein the storage container is a shore-based petroleum tank.

5. The apparatus of claim 1, wherein the shutdown valve of the vapor collection safety unit comprises a valve responsive to abnormal pressure conditions.

6. The apparatus of claim 1, wherein the shutdown valve of the vapor collection safety unit comprises a valve responsive to abnormal conditions in the apparatus.

7. The apparatus of claim 1, further including:
an alarm operable in response to sensed abnormal conditions and indicating the presence of abnormal conditions.

8. The apparatus of claim 1, wherein the cooler module comprises a plurality of sequentially connected cooler stages, each cooling an incoming vapor fluid and separating the incoming vapor into a liquid and a volatile organic compound vapor.

9. The apparatus of claim 1, further including a turbo-expander module connected to the cooler module.

10. The apparatus of claim 1, wherein the vapor scavenger unit comprises an engine consuming the volatile organic fluid vapor received from the cooler module as fuel.

11. The apparatus of claim 1, wherein the vapor scavenger unit comprises a molecular absorber for collecting the volatile organic fluid vapor received from the cooler module.

12. A mobile apparatus for recovery of volatile organic compound vapor from a vaporous fluid containing volatile organic compounds during transfer from a storage container for pollution reduction, comprising:
a scrubber unit connected to the vapor collection safety unit removing corrosive compounds from the vaporous fluid transferred from the storage container;
a compressor unit connected to the scrubber unit compressing the vaporous fluid after removal of corrosive compounds in the scrubber unit;
a liquid-vapor separator module connected to the compressor unit, the liquid-vapor separator module having a liquid outlet for liquids separated from vaporous fluid received from the compressor unit and a vapor outlet for vapors separated from vaporous fluid received from the compressor unit;
a cooler module connected to the vapor outlet of the liquid-vapor separator module and cooling the vapor received into a recovered volatile organic compound liquid and a recovered volatile organic compound vapor;
a fluid supply for supplying operating fluid; and
a vapor scavenger unit connected to the cooler module for utilizing the recovered volatile organic compound vapor.

13. The apparatus of claim 12, wherein the scrubber unit, compressor unit, liquid-vapor separator module, cooler module, fluid supply and vapor scavenger unit are mounted on a common platform.

14. The apparatus of claim 12, wherein the fluid supply comprises a coolant supply of coolant fluid for the cooler module.

15. The apparatus of claim 12, wherein the vapor scavenger unit comprises an engine an engine consuming the volatile organic fluid vapor received from the cooler module, and the fluid supply comprises a fuel supply for the engine.

16. The apparatus of claim 15, wherein the fluid supply further comprises a coolant supply of coolant fluid for the cooler module.

17. A mobile apparatus for recovery of volatile organic compound vapor from a vaporous fluid containing volatile organic compounds during transfer from a storage container for pollution reduction, the mobile apparatus comprising:
a vapor recovery module, the vapor recovery module comprising:
a vapor collection safety unit connected in a fluid transfer conduit from the storage container for receiving the vaporous fluid, the vapor collection safety unit comprising a shutdown valve coupled to a processor, the processor being configured to actuate, upon detection of a hazardous condition, the shutdown valve to block the fluid transfer conduit for containing the hazardous condition within the mobile apparatus;
a scrubber unit connected to the vapor collection safety unit configured to remove corrosive compounds from the vaporous fluid transferred from the storage container;
a compressor unit connected to the scrubber unit configured to compress the vaporous fluid after removal of corrosive compounds in the scrubber unit;
a liquid-vapor separator module connected to the compressor unit, the liquid-vapor separator module having a liquid outlet for liquids separated from vaporous fluid received from the compressor unit and a vapor outlet for vapors separated from the vaporous fluid received from the compressor unit;
a cooler module connected to the vapor outlet of the liquid-vapor separator module and configured to cool the vapor received into a recovered volatile organic compound liquid and a recovered volatile organic compound vapor;
a vapor scavenger unit connected to the cooler module and configured to utilize the recovered volatile organic compound vapor;
a platform having the vapor recovery module mounted therewith; and
an enclosure mounted with the platform and configured to enclose the vapor recovery module,
wherein the vapor collection safety unit further comprises a detonation arrestor arranged upstream of an inlet of the scrubber unit.

18. The apparatus of claim 17, wherein the enclosure comprises:
a frame comprising support members extending upwardly from the platform;
side wall members mounted in sealing engagement with the support members of the frame and forming a side wall of the enclosure;
a roof mounted above the frame and the side wall members and in sealing engagement therewith, the roof configured to form a top closure of the enclosure;
a ventilator fan mounted with one of the side wall members and configured to draw air into the enclosure; and
an outlet vent mounted with one of the side wall members and configured to allow air to exit from the enclosure.

19. The apparatus of claim 18, wherein the enclosure comprises:
a plurality of sealable access doors formed in the side wall of the enclosure.

20. The apparatus of claim 18, wherein the support members, side wall members and roof are formed of carbon steel.

21. The apparatus of claim 20, wherein the upright support members, side wall members and roof are coated with marine epoxy.

22. The apparatus of claim 18, further including a cooler compartment in the enclosure containing the cooler module therein.

23. A mobile apparatus for recovery of volatile organic compound vapor from a vaporous fluid containing volatile organic compounds during transfer from a storage container for pollution reduction, comprising:
a scrubber unit removing corrosive compounds from the vaporous fluid transferred from the storage container, the scrubber unit having sensors for monitoring process conditions therein and control members connected therewith for controlling fluid conditions in therein;
a compressor unit connected to the scrubber unit compressing the vaporous fluid after removal of corrosive compounds in the scrubber unit, the compressor unit having sensors for monitoring process conditions therein and control members connected therewith for controlling fluid conditions therein;
a liquid-vapor separator module connected to the compressor unit, the liquid-vapor separator module having a liquid outlet for liquids separated from vaporous fluid received from the compressor unit and a vapor outlet for vapors separated from vaporous fluid received from the compressor unit, the liquid-vapor separator module having sensors for monitoring process conditions therein and control members connected therewith for controlling fluid conditions therein;
a cooler module connected to the vapor outlet of the liquid-vapor separator module and cooling the vapor received into a recovered volatile organic compound liquid and a recovered volatile organic compound vapor, the cooler module having sensors for monitoring process conditions therein and control members connected therewith for controlling fluid conditions therein;
a vapor scavenger unit connected to the cooler module for utilizing the recovered volatile organic compound vapor, the vapor scavenger unit having sensors for monitoring process conditions therein and control members connected therewith for controlling fluid conditions therein;
a processor control computer having an established set of state points stored therein to establish operating conditions for the apparatus, the processor control computer further monitoring the sensors and adjusting the control members of the apparatus according to the established operating conditions.

24. The apparatus of claim 23, further including:
a vapor collection safety unit connected in a fluid transfer conduit from the storage container for receiving the vaporous fluid, the vapor collection safety unit containing a shutdown valve responsive to hazardous conditions to block the fluid transfer conduit.

25. The apparatus of claim 23, further including:
a fluid supply for supplying operating fluid.

26. The apparatus of claim 23, wherein the scrubber unit, compressor unit, liquid-vapor separator module, cooler module, fluid supply and vapor scavenger unit comprise a vapor recovery module mounted on a common platform, and further including:
an enclosure mounted with the platform and enclosing the vapor recovery module.

27. The apparatus of claim 17, wherein the storage container is a cargo tank.

28. The apparatus of claim 27, wherein the cargo tank is located in a marine vessel.

29. The apparatus of claim 17, wherein the storage container is a shore-based petroleum tank.

30. The apparatus of claim 17, further comprising:
an alarm operable in response to the detection of the hazardous condition and indicating the presence of the hazardous condition.

31. The apparatus of claim 17, wherein the cooler module comprises a plurality of sequentially connected cooler stages, each cooling an incoming vapor fluid and separating the incoming vapor into a liquid and a volatile organic compound vapor.

32. The apparatus of claim 17, further comprising:
a turbo-expander module connected to the cooler module.

33. The apparatus of claim 17, wherein the vapor scavenger unit comprises an engine consuming the volatile organic fluid vapor received from the cooler module as fuel.

34. The apparatus of claim 17, wherein the vapor scavenger unit comprises a molecular absorber for collecting the volatile organic fluid vapor received from the cooler module.
